(19) United States
(12) Patent Application Publication
(10) Pub. No.: US 2009/0129591 A1
(43) Pub. Date: May 21, 2009

(54) Techniques for Securing Document Content in Print and Electronic Form

(76) Inventors: Gregory A. Hayes, Coldwater, MI (US); David G. Kuehr-McLaren, Apex, NC (US); Ranjan Kumar, Durham, NC (US); Kwabena Mireku, Durham, NC (US); Govindaraj Sampathkumar, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/943,662

(22) Filed: Nov. 21, 2007

(51) Int. Cl. H04N 1/44

(52) U.S. Cl. 380/51

(57) ABSTRACT

A technique for securing selected document content includes receiving, at a printer, an unsecured electronic document. Selected content of the electronic document is then encrypted, with an encryption key, at the printer. A paper document whose content includes the encrypted selected content of the electronic document is then printed. The encrypted selected content of the paper document is unintelligible prior to decryption with a decryption key.

### BACKGROUND

1. Field

This disclosure relates generally to securing document content and, more specifically, to techniques for securing document content in print and electronic form.

2. Related Art

Static content contained in, for example, a word processing document or a portable data file may be printed on paper for a variety of reasons, such as convenience of reading, record maintenance, documentary evidence, etc. In general, documents have traditionally been printed on paper in such a way as to ensure readability, i.e., documents have traditionally been printed on paper in plain text and in a language that is understood by an intended recipient. Unfortunately, when a document is printed on paper in plain text, the document may be read by anyone who comes into possession of the document. In this case, when a physical paper document comes into the possession of an unauthorized recipient, theft of critical information from the document may occur.

Whether a document comes into the possession of an unauthorized recipient through international or industrial espionage, an information leak, identity theft, data misuse, inadvertent disclosure, or by some other means, the information in the document is compromised and may be used to the disadvantage of an owner of the information. To prevent data theft, various measures have been taken to secure printed (paper) documents. For example, access to paper documents that include sensitive information has been physically restricted to those having a need to know (e.g., by maintaining the document under lock). As other examples, paper documents containing sensitive information have been maintained in a secured area of a building and have been placed in a sealed envelope during transit, etc. While the above mentioned techniques reduce the risk of inadvertent disclosure, if a paper document comes into the possession of an unauthorized recipient, sensitive content of the document may be compromised. Electronic devices (such as a Sony reader), where text persists on a display of the device following a power cycle, may also facilitate the inadvertent leaking of sensitive information in electronic form.

Various techniques have been employed to secure document content in electronic form. For example, secure hyper-text transfer protocol (SHTTP) is an embedded encryption protocol that facilitates encrypting portions of a hyper-text markup language (HTML) page. While SHTTP protects document content to some extent, unfortunately, SHTTP utilizes a central processing unit (CPU) of a computer system and browser software that executes on the computer system to secure content and, as such, a decrypted document on the computer system is subject to remote attack. Moreover, SHTTP does not protect content of a document in print (paper) form.

### SUMMARY

According to one aspect of the present disclosure, a technique for securing selected document content includes receiving, at a printer, an unsecured electronic document. Selected content of the electronic document is then encrypted (with an encryption key) at the printer. A paper document, whose content includes the encrypted selected content of the electronic document, is then printed. The encrypted selected content of the paper document is unintelligible prior to decryption (with a decryption key).

According to another aspect of the present disclosure, a technique for securing selected document content includes determining, at a display device, whether a recipient is authorized to access encrypted content of an electronic document. When the recipient is authorized to access the encrypted content of the electronic document, the encrypted content of the electronic document is decrypted (with a decryption key) at the display device. The decrypted content of the document is then provided to the recipient in an intelligible form on a display screen of the display device, when the recipient is authorized to access the encrypted content of the electronic document.

According to another aspect of the present disclosure, a technique for securing selected document content includes scanning, using a scanner, a paper document to provide an electronic document. Next, it is determined, at the scanner, whether a recipient is authorized to access encrypted content of the electronic document. The encrypted content of the electronic document is then decrypted, at the scanner, with a decryption key when the recipient is authorized to access the encrypted content of the electronic document. Finally, the decrypted content of the document is provided, at the scanner, to the recipient in an intelligible form when the recipient is authorized to access the encrypted content of the electronic document.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of an example computer system providing an unsecured electronic document to a printer that is configured to provide a secured paper document, according to one aspect of the present disclosure.

FIG. 2 is a diagram of an example computer system providing a secured electronic document to a monitor that is configured to display an unsecured electronic document on a display screen, according to one aspect of the present disclosure.

FIG. 3 is a diagram of a scanner that is configured to access secured content of a secured paper document, according to one aspect of the present disclosure.

FIG. 4 is a flowchart of an example process for converting secured content of a document to non-secured content, according to the present disclosure.

FIG. 5 is a flowchart of an example process for rendering an electronic document in a desired form, according to the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to an electronic, magnetic, optical, electromagnetic, infrared, or semiconductor system, apparatus, or device. More specific examples (a non-exhaustive list) of the computer-readable medium storage would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus implement the functions/acts specified in the flowchart and/or block diagram block or blocks. As used herein, the term “coupled” includes both a direct electrical connection between blocks or components and an indirect electrical connection between blocks or components achieved using intervening blocks or components.

According to various aspects of the present disclosure, techniques are employed to enhance security of static content, such as the content of printed documents or devices that provide a persistent document display (e.g., a Sony reader), by ensuring that only authorized recipients have access to sensitive document content. According to various embodiments of the present disclosure, decrypting of encrypted portions of a document is performed by a device that renders electronic (e.g., a monitor) or paper documents (e.g., a printer), as contrasted with document decryption using vulnerable components (e.g., a central processing unit (CPU), a memory subsystem, system software, and/or a hard disk drive (HDD)) of a computer system. According to the present disclosure, when a document is rendered in printed form on paper (by a printer) or in an electronic form (by an application) in a “what you see is what you get” (WYSIWYG) format (such as portable data file (PDF), a WORD document, or an eBook), sensitive content of the document is secured.

An intended document recipient may then view the document with a display device that is configured to decrypt the document. In the case of a physical paper document, a scanner may be configured to decrypt encrypted portions of the document and provide (audibly or visually) the decrypted information to an authorized recipient. Employing the disclosed techniques generally reduces the need to shred paper documents and generally reduces loss of sensitive data (through data theft (intentional) or data leakage (unintentional)). Moreover, the disclosed techniques reduce the opportunity for man-in-the-middle attacks for documents in transit and reduce exposure when WYSIWYG forms of a document are printed. Furthermore, the disclosed techniques reduce exposure when electronic versions of a document are misrouted or stolen and facilitate electronic declassification of documents for archivists.

The techniques disclosed herein encrypt and/or sign an entire document (or selected sections of the document) with one or more keys that are known to a display device (e.g., a monitor) or scanner (for a printed paper document) associated with an authorized recipient. In general, a display device of an authorized recipient is configured to decrypt encrypted portions of a document immediately prior to display. Similarly, a scanner of an authorized recipient is configured to decrypt encrypted portions of a document immediately prior to providing (e.g., audibly or visually) the information to the authorized recipient. The disclosed techniques may be employed in a number of different applications. For example, the disclosed techniques may be utilized in securing documents in printed form, performing confidential record maintenance, facilitating confidential communications, securing confidential forms (e.g., W2s, tax reports, etc., where, for example, a social security number (SSN) field is encrypted), classification of government documents (electronic version of a black marker that can be reversed by archivist when the information is declassified), and facilitating multi-level security (e.g., where a different security clearance level unlocks different documents or different portions of a document).

In general, document securing techniques disclosed herein consider two parties, i.e., a document printer and a document recipient. The document printer is an individual who prints out a document and who may or may not be authorized to view content of the document. As used herein, the term “printed document” includes documents in an electronic form, such as a portable data file (PDF), and documents in paper form. An authorized recipient is an individual who is authorized to receive (hear or read) sensitive content of a document. According to various aspects of the present disclosure, documents, such as classified and confidential documents, are only printable in an encrypted form. The printed encrypted document may take the form of a hex dump or bitwise representation of the secured information in the document. According to various aspects of the present disclosure, a display device (e.g., an eBook reader) is configured to read an encrypted document in electronic form and a scanner (e.g., a document scanner of a pen computer) is configured to read an encrypted document in print form.

According to one or more embodiments of the present disclosure, a number of different software routines may be employed to secure documents or portions of documents. For example, a first routine that performs character recognition of bits in a scanned document may be employed in a scanner. A second routine that authenticates and authorizes a recipient may also be employed in the scanner. For example, authentication and authorization methodologies, including private key infrastructure (PKI), may be employed to authenticate and authorize a recipient to access secured documents or secure sections of documents. A third routine may be employed to decrypt encrypted sections of the document. The third routine may be embodied in software, firmware, or hardware. In general, the third routine is integrated into a display device or a scanner that decrypts one or more encrypted sections of a document after determining that the reader is authorized to view an unencrypted version of the document.

When a document is created in a form that can be printed, the sensitive portions of the document are encrypted with a key (or set of keys) that may be replicated in a display device or scanner of an intended recipient to decrypt the document. The document creation process produces either an electronic WYSIWYG form of the document that can be printed, or a printed paper copy with sensitive fields of the document encrypted and/or digitally signed. The keys to decrypt and verify documents can be plugged into a display/scanning device of an authorized recipient in the form of cryptography hardware, firmware, or software. To reduce vulnerability to viruses and intrusions, according to one or more embodiments, the keys and the process to decrypt and verify the document are not located on a computer system (e.g., a workstation or laptop computer) of an intended recipient or other intermediate computers.

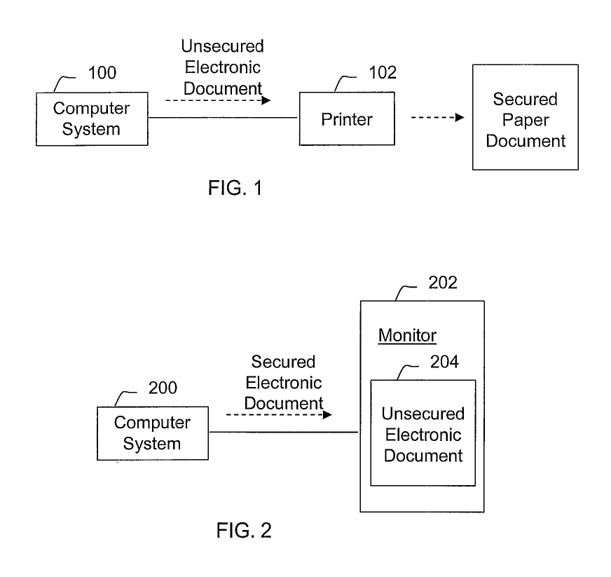

FIG. 1 depicts a computer system 100 that is coupled to a printer 102 that is configured to encrypt (all or a portion of) an unsecured electronic document prior to printing a paper copy of the document. An originator of the unsecured document may mark sensitive portions of the document in a variety of different manners. When the printer 102 receives the document for printing, the printer detects the sensitive portions of the document and encrypts the sensitive portions accordingly. For example, sensitive portions of the document may be highlighted by the originator and the printer 102 may be configured to detect and encrypt the highlighted portions of the unsecured electronic document prior to printing a secured document.

With reference to FIG. 2, a computer system 200 is depicted that is coupled to a monitor 202 that is configured to decrypt secured electronic documents prior to displaying the document on a display screen 204 of the monitor 202. The secured (encrypted) electronic document may be created from a scanned paper copy or correspond to an electronic document (e.g., a portable data file, word processing document, etc.) that was rendered by an associated application on a secured computer system. In the case of an electronic document, an originator of the document may mark sensitive portions of the document prior to saving the document to an electronic file. When an application executing on the secured computer system saves the document, the application detects the sensitive portions of the document and encrypts the sensitive portions accordingly. For example, sensitive portions of the document may be underlined by a creator of the document and the application that renders the secured document may be configured to detect and encrypt the underlined portions of the document. In this manner, a secured electronic file may be sent via regular email to an authorized recipient with reduced concern for theft of sensitive information. When the computer system 200 sends the secured document to the monitor 202 for display, the monitor 202 decrypts the secured document and displays an intelligible document on an the display screen 204. In this case, the computer system 200, which is not secure, only maintains secured electronic documents.

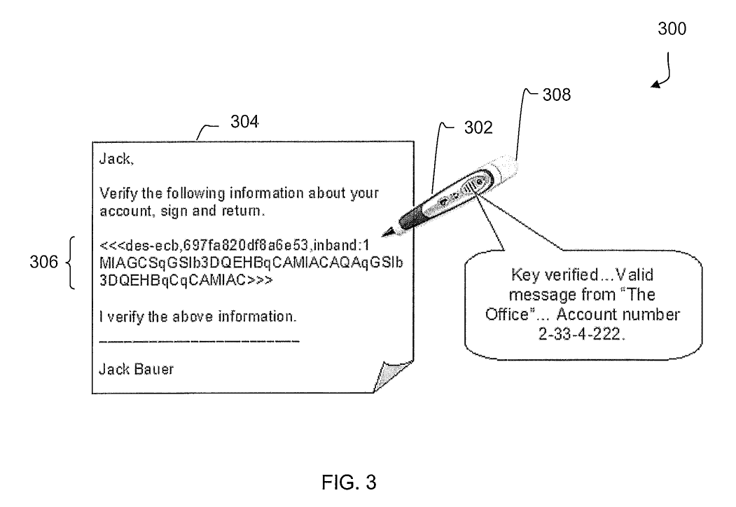

With reference to FIG. 3, an example of a printed document 304 with an encrypted section 306 that is scanned by a reading device (e.g., handheld or flatbed scanner) 302 is depicted. The scanner 302 is configured to decrypt sensitive portions 306 of the document 304, when an authorized user requires the information. The scanner 302 decrypts the encrypted portion 306 of the document 304 and audibly provides (in this case) the information to an authorized recipient. The scanner 302 may accept, for example, a pluggable module 308 that includes information that authenticates a user and provides one or more keys to decrypt encrypted information, e.g., financial account information, in the document 304.

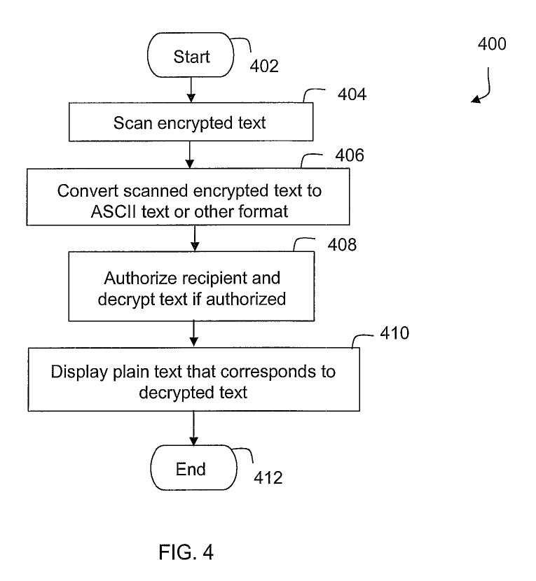

With reference to FIG. 4, an example process 400 of how secured content of a document may be recovered, according to one or more aspects of the present disclosure, is illustrated. A device, such as the scanner 302, may be utilized to decrypt the encrypted portions 306 of the document 304. The process 400 is initiated in block 402, at which point control transfers to block 404. In block 404, the scanner 304 is utilized to scan the encrypted portion 306 of the document 304. Next, in block 406, the scanner 302 utilizes embedded optical character recognition (OCR) firmware that converts the scanned information into ASCII text, or another desired format. Then, in block 408, the scanner 302 accesses the pluggable module 308, which includes one or more keys of an authorized recipient. Next, in block 410, the scanner 302 uses the one or more keys to decrypt the encrypted portion(s) 306 of the document 304. The scanner 302 may also verify an origin of the document by, for example, verifying a signature or key of an originator. Text, in a decrypted form, is then provided (visually or audibly) to the recipient. In an alternative embodiment, the scanner 302 may only be utilized to convert a secured paper document into a secured electronic document. In this case, the secured electronic document may be provided to a display device that is configured to decrypt and display the secured electronic document.

In the case of a WYSIWYG display device, the display device (e.g., a monitor or an eBook reader), as opposed to an unsecured computer system, contains the keys and processes to decrypt and verify a document. The display device can be a monitor that has been enhanced to decrypt the sensitive information as part of the graphical display process (e.g., built into a graphics card and using OCR technology) or an electronic document reader that is configured to received a pluggable module (that includes decryption keys, etc.) of an authorized user.

As an example of another embodiment, the disclosed techniques may be incorporated into a pair of eyeglasses that include a retinal scanner (that authenticates a recipient based on a retinal scan) and a renderer (that displays “on demand” the scanned and decrypted version of the document being read within the scope of the eye glasses). It is contemplated that the techniques disclosed herein may also be applied to pictures embedded in documents and character sets other than ASCII character sets (e.g. Arabic character sets, Chinese character sets, etc.). Moreover, the techniques disclosed herein can be used to embed other information that is not necessarily encrypted, but represents an embedded object that would require a binary representation (e.g., sound).

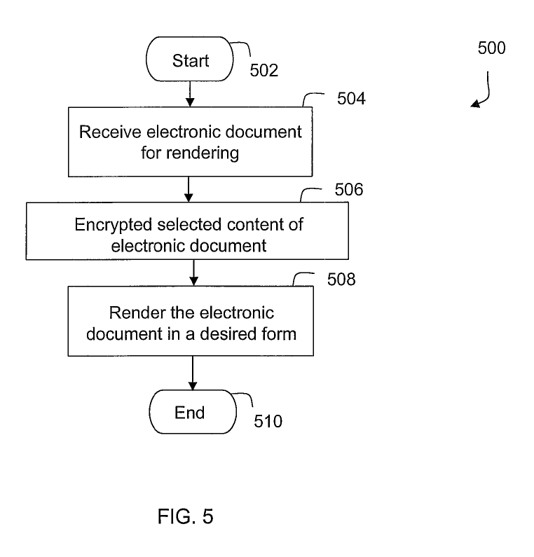

With reference to FIG. 5, a process 500 for rendering an electronic document in a desired form (e.g., in electronic form or printed form) is depicted. The process 500 is initiated in block 502, at which point control transfers to block 504. In block 504, an electronic document is received for rendering, e.g., by an application or a printer. Next, in block 506, selected content of the electronic document is encrypted. As noted, the content that is to be encrypted may be indicated in a number of different ways (highlighted, underlined, etc.). The selected content of the document is then secured by an application or a printer prior to rendering (i.e., a secure application may render secured content into a file or the printer may render secured content on a printed page). Next, in block 508, the selected content is rendered in a desired form. Following block 508, control transfers to block 510 where the process 500 terminates.

Accordingly, techniques have been disclosed herein that facilitate securing document content in print and electronic form.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of securing selected document content, comprising:
receiving, at a printer, an unsecured electronic document;
encrypting, at the printer, selected content of the electronic document with an encryption key; and
printing a paper document whose content includes the encrypted selected content of the electronic document, wherein the encrypted selected content of the paper document is unintelligible prior to decryption with a decryption key.

2. The method of claim 1, wherein the unsecured electronic document is a word processing document.

3. The method of claim 1, wherein the encrypted selected content includes financial account information.

4. The method of claim 1, wherein the unsecured electronic document is a portable data file.

5. The method of claim 1, wherein the encryption key and the decryption key are the same.

6. A method of securing selected document content, comprising:
determining, at a display device, whether a recipient is authorized to access encrypted content of an electronic document;
decrypting, at the display device, the encrypted content of the electronic document, with a decryption key when the recipient is authorized to access the encrypted content of the electronic document; and
providing the decrypted content of the document to the recipient in an intelligible form on a display screen of the display device when the recipient is authorized to access the encrypted content of the electronic document.

7. The method of claim 6, further comprising:
scanning a paper document to provide the electronic document.

8. The method of claim 6, wherein the electronic document is a portable data file.

9. The method of claim 6, wherein the decryption key is the same as an encryption key used to provide the encrypted content.

10. A method of securing selected document content, comprising:
scanning, using a scanner, a paper document to provide an electronic document;
determining, using the scanner, whether a recipient is authorized to access encrypted content of the electronic document;
decrypting, using the scanner, the encrypted content of the electronic document with a decryption key when the recipient is authorized to access the encrypted content of the electronic document; and
providing, using the scanner, the decrypted content of the document to the recipient in an intelligible form when the recipient is authorized to access the encrypted content of the electronic document.

11. The method of claim 10, wherein the intelligible form corresponds to synthesized speech in a language understood by the recipient.

12. The method of claim 10, wherein the decrypted content of the document is visually provided to recipient of a display.

13. The method of claim 10, wherein the decryption key is the same as an encryption key used to provide the encrypted content.
